(19) United States
(12) Patent Application Publication
(10) Pub. No.: US 2012/0049543 A1
(43) Pub. Date: Mar. 1, 2012

(54) HOOD LATCH MODULE USING POP-UP SPRING

(75) Inventor: Hyeon Jung Park, Suwon-si (KR)

(73) Assignees: Kia Motors Corporation, Seoul (KR); Hyundai Motor Company, Seoul (KR)

(21) Appl. No.: 12/938,038

(22) Filed: Nov. 2, 2010

(30) Foreign Application Priority Data
Aug. 31, 2010 (KR) 10-2010-0084461

(51) Int. Cl. E05C 3/12

(52) U.S. Cl. 292/220

(57) ABSTRACT

The present invention provides a hood latch module that can minimize the volume of the latch module by removing a latch spring of a hood latch and by using a torsion spring with a small volume and can reduce noise generated by vibration of the spring by improving an coupling structure of a pawl and the latch. The hood latch module comprises: a release cable configured to transmit a hood opening force; a pawl coupled to one side of the release cable so as to be rotated; a latch configured to interact with rotation of the pawl to be rotated and to couple and fix a hood striker; and a pop-up spring configured to contact with the hood striker at one side thereof. The pop-up spring is deformed as the hood striker is coupled with and fixed to the latch when the hood is closed and applies a restoring force as the hood striker is released to withdraw the hood striker from the latch when the hood is opened.

### CROSS-REFERENCE TO RELATED APPLICATION

The present application claims priority to Korean Patent Application No. 10-2010-0084461 filed Aug. 31, 2010, the entire contents of which is incorporated herein for all purposes by this reference.

### BACKGROUND OF THE INVENTION

1. Field of the Invention

The present disclosure relates to a hood latch module using a pop-up spring. More particularly, it relates to a hood latch module that can minimize the volume of the latch module by removing a latch spring from the hood latch module and by using a torsion spring with a small volume. Furthermore, the hood latch module can reduce noise caused by vibration of a pawl spring by improving a coupling structure of a pawl and the latch.

2. Description of Related Art

A hood covers an engine compartment generally located at the front side of a vehicle. The front side of the hood is pivotally lifted up about hinges formed at the rear side thereof. A locking unit is often mounted to the front side of the hood to prevent the hood from being opened during driving of the vehicle. The hood can be opened by control of a hood lever provided on either side of the driver's seat.

Hereinafter, a general process of opening a vehicle hood is as follows. As a driver manipulates a hood open lever, a release cable operably connected to one end the lever is drawn to rotate a pawl to which the other end of the release cable is connected. Subsequently, coupling between a stopping step of a latch and the pawl is disengaged. Upon such disengagement between the stopping step and the pawl, the latch is then opened to release a hood striker therefrom. Namely, the hood striker is released from the latch so as to be provisionally released state.

In the provisionally released state, the hood is slightly lifted up with a certain gap, not fully opened, due to constraint of a safety lever. The locking state of the striker is released second by manipulating a safety lever installed in the latch module, allowing the hood to be fully opened.

Meanwhile, when the coupling of the pawl and the latch is disengaged, the latch should rotate to push away the hood striker. For the sake of the forcible rotation of the latch, a latch spring is generally provided. However, since the latch spring functions both to rotate the latch and to pop up the striker so that the striker can be withdrawn from the latch, it needs a strong elastic force. Thus, a spring having a large volume and a strong elastic force is used for it. Thus, the latch spring increases the volume and weight of the latch module. In particular, there is a difficulty in practically manufacturing a latch module suitable for a compact car.

Meanwhile, a latch module is generally located at the front side of a hood where the first place to be shocked in case of a head-on collision of a vehicle. Especially, when such a head-on collision is involved with pedestrians, it becomes critical to ensure sufficient void space at the place where the latch module is installed for the sake of pedestrians' safety. However, when the volume of the latch module is large, it is difficult to secure a sufficient shock absorbing space at the front side of the vehicle, which is disadvantageous in protecting the pedestrian during the collision.

Moreover, in the conventional latch module, one side of the pawl spring is mounted to the pawl and the opposite end thereof is fixed to a base, in which case when vibrations occur during driving of the vehicle, noise is generated in the pawl spring. That is, since the base of the latch module is fixed to the vehicle and the pawl can be moved by an interval within the latch module, the pawl spring connected between the base and the pawl may be shaken due to the vibrations of the vehicle. In that case, the outer surface of the pawl spring needs to be coated with rubber in order to reduce noise.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE DISCLOSURE

Various aspects of the present invention are directed to reduce the volume of a latch module by improving the structure of the latch module for pop-up of a hood striker and to reduce noise caused by vibration of a vehicle by improving the coupling structure of a pawl spring.

In one aspect, the present invention provides a hood latch module comprising: a release cable configured to transmit a hood opening force; a pawl coupled to one side of the release cable so as to be rotated; a latch configured to interact with rotation of the pawl to be rotated and to couple and fix a hood striker; and a pop-up spring configured to contact with the hood striker at one side thereof, wherein the pop-up spring is deformed as the hood striker is coupled with and fixed to the latch when the hood is closed and applies a restoring force as the hood striker is released to withdraw the hood striker from the latch when the hood is opened.

The pop-up spring may be a torsion spring.

The hood latch module may further comprise a pawl spring configured to connect the pawl and the latch, wherein the latch interacts with the pawl to be rotated through the pawl spring.

According to the hood latch module using a pop-up spring, the volume of the latch module can be minimized and the weight of the latch module can be reduced by using a torsion spring.

Further, a structure suitable for manufacturing a latch module of a compact car can be suggested by reducing the volume of the latch module, making it possible to secure a shock absorbing space against a collision accident.

Furthermore, a hood striker can be stably popped up through a V-shaped groove formed between a latch and a torsion spring without being slid when a first locked state of the hood striker is released, and can be stably supported even in a state in which the first locked state is released.

In addition, noise of a pawl spring generated by vibrations of a vehicle can be remarkably reduced.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a front perspective view illustrating a hood latch module using a pop-up spring according to an exemplary embodiment of the present invention,

FIG. 2 is a rear perspective view illustrating the hood latch module using a pop-up spring according to the exemplary embodiment of the present invention, and

FIG. 3 shows front views illustrating an opening operation of the hood latch module according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

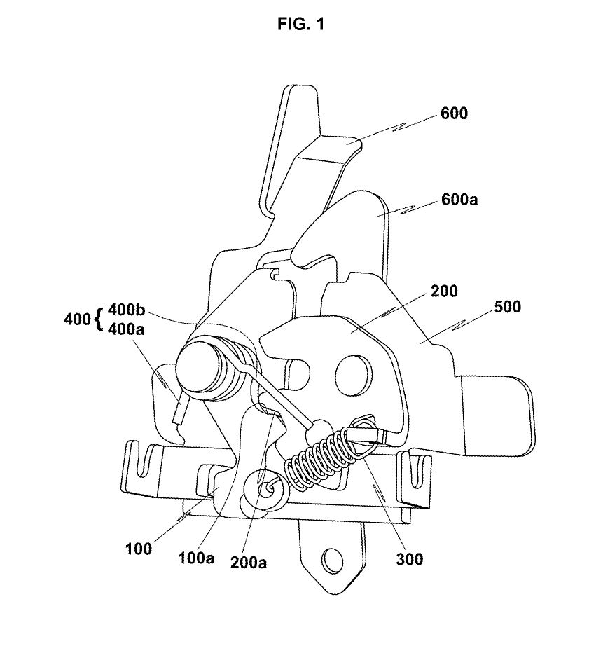

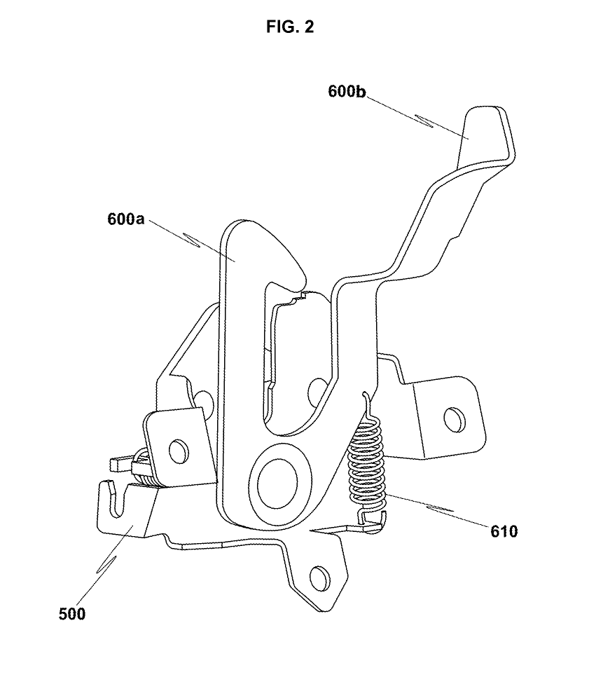

FIGS. 1 and 2 illustrate a structure of a hood latch module according to an exemplary embodiment of the present invention. Referring to FIGS. 1 and 2, the hood latch module according to an exemplary embodiment of the present invention may include a pawl 100, a latch 200, a pawl spring 300, and a pop-up spring 400.

In the exemplary embodiment of the present invention, the pawl 100 may interact with the latch 200 to be rotated, and may receive a hood opening force of a user through a release cable.

A pawl stopping step 100a and a latch stopping step 200a are respectively formed in the pawl 100 and the latch 200 such that the pawl 100 and the latch 200 can be fixed to and coupled with each other with the hood being closed. That is, since the latch stopping step 200a is caught by the pawl stopping step 100a to maintain the latch 200 fixed with the hood being closed. However, the configuration of the stopping step is not limited to that illustrated in the figures, but may be formed on only one side of the pawl 100 and the latch 200 and various other coupling structures may be used.

The pawl 100 and the latch 200 are rotated by a predetermined angle as the striker is introduced into the latch when the hood is closed, and are rotated in the opposite direction such that the hood striker can be withdrawn from the latch when the hood is opened.

The hood latch module according to the exemplary embodiment of the present invention may include a pop-up spring 400. When the hood is opened, as the hood striker is released from the latch 200, the pop-up spring 400 applies a restoring force to the hood striker to withdraw the hood striker from the latch 200 and thus pop up the hood.

In the exemplary embodiment of the present invention, a torsion spring may be used as the pop-up spring 400. The torsion spring may be coupled to the hood latch module of the present invention such that one side 400b contacts with the hood striker and the opposite side 400a thereof remains fixed. The torsion spring generates a restoring force circumferentially when a torsion force occurs, and the hood striker is withdrawn from the latch 200 using the restoring force. Then, the torsion spring occupies a small volume relative to the restoring force, thereby reducing the volume of the latch module having the torsion spring.

Meanwhile, according to the exemplary embodiment of the present invention, a pawl spring 300 may connect the pawl 100 and the latch 200 to allow the latch 200 to interact with the pawl 100 to be rotated. More preferably, the pawl spring 300 connects the pawl 100 and the latch 200 and applies a tension between the pawl 100 and the latch 200. Thus, when the pawl 100 is rotated in the clockwise direction as the hood is opened, the latch 200 may also be rotated in the clockwise direction by the pawl spring 300. On the other hand, when the latch 200 is rotated in the counterclockwise direction as the hood is closed, the latch 200 may also be rotated in the counterclockwise direction.

In an exemplary embodiment of the present invention, the reference numeral 500 indicates a base, which may function as a support plate to which elements of the latch module can be fixed.

Meanwhile, the hood latch module of the present invention may include a safety hook 600a and a safety lever 600b. The safety hook 600a is hook-shaped, and performs a second locking operation of allowing the hook striker released first by the latch 200 to be caught by and fixed to the bottom surface of the safety hook 600a second. The safety hook 600a is opened by the operation of the safety lever 600b and thus the second locking state of the hood striker can be released.

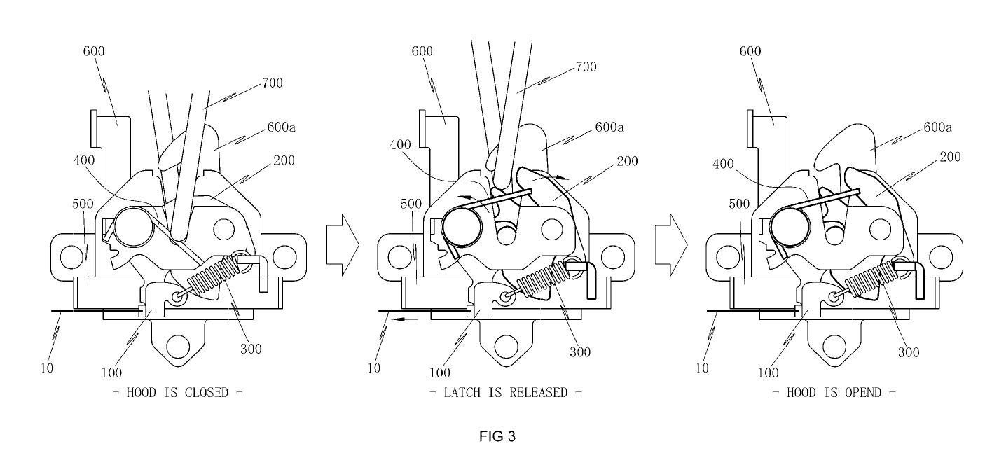

FIG. 3 illustrates a process of opening the hood according to the exemplary embodiment of the present invention. First, the hood striker 700 is introduced into the latch 200 with the hood being closed, and the pop-up spring 400 whose side contacts with the hood striker 700 is distorted and compressed. Then, as described above, the latch 200 is fixed as the pawl 100 and the stopping steps 100a and 200a are coupled to each other.

Then, if the user operates a hood lever to open the hood, the opening force is transmitted to the pawl 100 through the release cable 10. The pawl 100 may be rotated in the clockwise direction by the tension of the release cable 10, and a rotational force may be transmitted to the latch 200 through the pawl spring 300 connected between the pawl 100 and the latch 200.

Then, the pawl spring 300 is temporarily expanded, and referring to FIG. 1, the coupling state of the pawl stopping step 100a and the latch stopping step 200a is released as the pawl 100 according to the present invention is rotated in the clockwise direction. In the process of releasing the coupling state of the pawl stopping step 100a and the latch stopping step 200a, the pawl stopping step 100a slides along the latch stopping step 200a such that the latch 200 can be rotated by a predetermined angle in the counterclockwise direction, and then the pawl spring 300 is temporarily expanded.

If the coupling state of the pawl stopping step 100a and the latch stopping step 200a is released, the latch 200 is rotated together in the clockwise direction by the tension of the pawl spring 300. That is, according to the exemplary embodiment of the present invention, the latch 200 interacts with the pawl 100 through the pawl spring 300 to be rotated together with the pawl 100. As the latch 200 is released from the pawl 100 in this way, the hood striker 700 is released from the latch 200 into a state in which it can be withdrawn from the latch 200.

If the hood striker 700 is released from the latch 200 in this way, one side 400a of the pop-up spring 400 is rotated in the counterclockwise direction by the restoring force of the compressed pop-up spring 400. That is, as one side 400b of the pop-up spring 400 which contacts with the hood striker 700 is rotated in the counterclockwise with the opposite side 400a of the pop-up spring 400 being fixed to the base 500, the restoring force of the pop-up spring 400 may be transmitted to the hood striker 700. The hood striker 700 that contacts with one side 400b of the pop-up spring 400 is withdrawn from the latch 200 by the restoring force of the pop-up spring 400, allowing the hood to be popped up. Then, the hood striker 700 is released from its first locked state by the latch 200, and is caught by the bottom surface of the safety hook 600a according to the exemplary embodiment of the present invention.

Meanwhile, in the process of withdrawing the hood striker 700 from the latch 200, the pop-up spring 400 and the latch 200 forms a V-shaped groove and the hood striker 700 is positioned in the V-shaped groove when it is withdrawn from the latch 200 to prevent the hood striker 700 from being shaken or slid. Further, the hood is stably supported by allowing the groove to stably support the hood striker 700 even in the first locked state.

If the safety lever 600b is operated in a state in which the first locked state of the hood striker is released, the safety hook 600a is rotated and opened in the clockwise direction, and the second locked state of the hood striker 700 by the safety hook 600a is also released to completely open the hood. Thereafter, the safety lever 600b may be returned to the original position by a spring 610.

As described above, the present invention is configured to pop up the hood in the situation in which the first locked state of the hood striker 700 is released, and can minimize the volume of the latch module and reduce the weight thereof by using the pop-up spring 400, and preferably the torsion spring. The pawl 100 and the latch 200 interact with each other to be rotated together through a single member, i.e. the pawl spring 300 and the pawl spring 300 is directly connected to the latch 200 instead of the base 500, making it possible to remarkably reduce noise of the pawl spring 300 generated by the vibrations of the vehicle. That is, the pawl 100 and the latch 200 can be moved with a certain gap within the latch module, and the opposite ends of the pawl spring 300 are moved in conjunction with the pawl 100 and the latch 200 in spite of the vibrations of the vehicle as they are coupled with the pawl 100 and the latch 200. Accordingly, the pawl spring 300 is restrained from being expanded or contracted due to the vibration of the vehicle, thereby reducing noise.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hood latch module comprising:
a release cable transmitting a hood opening force;
a pawl rotatably mounted to a base, wherein one end portion of the pawl is coupled to one end of the release cable so as to be rotated by the release cable;
a latch rotatably mounted to the base and interacting with the pawl to be rotated and to receive a hood striker therein; and
a pop-up spring, one end of which is connected to the base and the other end of which selectively contacts with the hood striker,
wherein the other end of the pop-up spring is deformed by the hood striker as the hood striker is engaged with the latch when the hood is closed and applies a restoring force to the hood striker as the hood striker is released from the latch while the hood is opened.

2. The hood latch module of claim 1, wherein the pop-up spring is a torsion spring.

3. The hood latch module of claim 1, further comprising a pawl spring elastically connecting the one end portion of the pawl with the latch, wherein the latch interacts with the pawl to be rotated through the pawl spring.
